(19) United States
(12) Patent Application Publication
(10) Pub. No.: US 2025/0233655 A1
(43) Pub. Date: Jul. 17, 2025

(54) SUBSEA FIBER OPTIC SYSTEM WITH REAL-TIME LONG DISTANCE DAS/DTS MEASUREMENTS

(71) Applicants: Chevron U.S.A. Inc., San Ramon, CA (US); Chevron Australia Pty Ltd, Perth (AU)

(72) Inventors: Masoud Hajiaghajani, Houston, TX (US); Minh Duc Vo, Perth (AU); Lee Eric Mitchell, Katy, TX (US)

(21) Appl. No.: 19/022,957

(22) Filed: Jan. 15, 2025

Related U.S. Application Data
(60) Provisional application No. 63/621,054, filed on Jan. 15, 2024.

(51) Int. Cl. H04B 10/071; H04B 10/25; H04B 10/80

(52) U.S. Cl. CPC H04B 10/071; H04B 10/2589; H04B 10/80

(57) ABSTRACT

A method includes: outputting optical signals to a first optical fiber via a first interrogator, the first interrogator located at a topside/onshore location, the first interrogator configured to collect distributed acoustic sensor (DAS) and/or distributed temperature sensor (DTS) measurements; outputting optical signals to a second optical fiber via a second interrogator, the second interrogator located subsea, the second interrogator configured to collect DAS and/or DTS measurements; receiving optical signals from the second optical fiber via the first interrogator; receiving optical signals from the first optical fiber via the second interrogator; providing acoustic, temperature, and/or vibration sensing along a portion of the second optical fiber via the first interrogator based on the optical signals received from the second optical fiber; and providing acoustic, temperature, and/or vibration sensing along a portion of the first optical fiber via the second interrogator based on the optical signals received from the first optical fiber.

### CROSS-REFERENCE TO RELATED APPLICATIONS

This application claims the benefit of and priority to U.S. Provisional Patent Application No. 63/621,054 titled “Subsea Fiber Optic System Architecture with Continuous Integrity Monitoring and/or Improved Optical Strength”, filed on Jan. 15, 2024.

### TECHNICAL FIELD

The present invention is directed to subsea fiber optic system architecture used for communications, control, sensing, and/or integrity monitoring in subsea operations, and more particularly, to systems and methods for providing real-time long distance DAS/DTS measurements in subsea fiber optic systems for fibers in service or spare fibers.

### BACKGROUND

Fiber optic cables are increasingly being used to provide control, communications, sensing, and/or integrity monitoring in subsea operations (e.g., operations that support offshore production of oil and gas). As a non-limiting example, optical fibers can be used to communicate and/or send control signals between topside or onshore facilities and subsea control systems, which are in turn used to control subsea operations such as, for example, operating subsea valves, pumps, compressors, or other equipment.

There are a number of drawbacks associated with existing subsea fiber optic systems being used for subsea control, communications, sensing, and/or integrity monitoring. First, the fiber optic systems may need to be taken offline in order to assess the integrity of the optical fiber using, for example, an optical time domain reflectometer (OTDR). Shutting down the live stream through the optical fibers can lead to undesirable system downtime for communications or equipment being controlled in response to the optical signals, resulting in lost profits or unexpected consequences. It is now recognized that a need exists for systems and methods to provide fiber optic integrity assessment without interrupting fiber optic system operations and leverage fiber optic capacity to perform the above features in parallel using shared fibers.

In addition to OTDR measurements, other types of optical fiber sensing may be desired, such as distributed acoustic sensor (DAS) and distributed temperature sensor (DTS) measurements. However, DAS and DTS provide sensing over a limited distance (e.g., 75-80 km) in fiber optic cables used for subsea control or communications due to fiber attenuation. Therefore, it is now recognized that enhanced methods need to be applied to extend DAS/DTS sensing distance up to 150 km or more.

Finally, subsea fiber optic systems have to reach long distances between topside/onshore equipment and certain subsea equipment. Large decibel losses can occur in the optical signals being communicated over such long fiber optic cables used in subsea applications. It is now recognized that a need exists for systems and methods to increase the range of fiber optic communications along lengthy fiber optic cables used for subsea operations, with or without a dedicated electrical power circuit.

### BRIEF DESCRIPTION OF THE DRAWINGS

The drawings illustrate only example embodiments and are therefore not to be considered limiting in scope, as the example embodiments may admit to other equally effective embodiments. The elements and features shown in the drawings are not necessarily to scale, emphasis instead being placed upon clearly illustrating the principles of the example embodiments. Additionally, certain dimensions or positions may be exaggerated to help visually convey such principles.

FIG. 1 is a schematic block diagram illustrating an example subsea fiber optic system in accordance with an embodiment of the present techniques.

FIG. 2 is a schematic block diagram illustrating an example long distance DAS/DTS measurement assembly in accordance with an embodiment of the present techniques.

FIG. 3 is a schematic block diagram illustrating another example long distance DAS/DTS measurement assembly in accordance with an embodiment of the present techniques.

FIG. 4 is a schematic block diagram illustrating an example assembly for powering a fiber optic booster/repeater in accordance with an embodiment of the present techniques.

FIG. 5 is a schematic block diagram illustrating another example assembly for powering a fiber optic booster/repeater in accordance with an embodiment of the present techniques.

FIG. 6 is a schematic block diagram illustrating an example subsea fiber optic system including an umbilical mid-line connection assembly (UMCA) in accordance with an embodiment of the present techniques.

FIG. 7 is a schematic block diagram illustrating the UMCA of FIG. 6 with an erbium doped fiber amplifier (EDFA) opto-electronic harness in accordance with an embodiment of the present techniques.

### DETAILED DESCRIPTION OF THE DRAWINGS

The example embodiments discussed herein are directed to systems, apparatus, and methods related to continuous integrity assessment of subsea fiber optic system and improving optical strength of said subsea fiber optic systems. Fiber optic systems may provide communications, control, sensing, and/or integrity monitoring signals between a topside or onshore location and a subsea location (e.g., a subsea controller). The disclosed systems and methods may apply different technologies such as OTDR, DAS, and/or DTS in parallel using the same fibers already in service for controls, sensing, and/or communications to continuously monitor features affecting the integrity of the optical fiber(s). An OTDR interrogator is used to determine fiber condition and properties, such as splice or connector losses and attenuation. DAS and DTS interrogators use backscatter and/or reflections from along the fiber to sense acoustic energy incident on the fiber (DAS), vibrations incident on the fiber, or ambient temperature around the fiber (DTS).

One aspect of the present disclosure relates to a fiber optic communication system configured for real time fiber optic integrity monitoring using DTS, DAS, and/or OTDR. The system may record the data received by the DTS, DAS, and/or OTDR interrogators in a historian server and provide post-processing of the data for diagnostics. This may allow continuous monitoring of the health of the system so that undesired changes to conditions can be identified in time to plan for mitigations. The architecture of certain disclosed fiber optic systems allows combining control/communication/sensing and integrity monitoring (e.g., as a part of integrity management) using shared optical fibers by leveraging various wavelengths within the shared fibers. In certain embodiments, the architecture of the fiber optic system may allow the use of common fibers for DTS/DAS and OTDR, thus reducing the number of fiber cables in the system.

Another aspect of the present disclosure relates to a configuration of DTS and/or DAS interrogators within a subsea fiber optic cable system that enables the range of DTS/DAS measurements to extend up to 150 km, up to 160 km, or more. A first DTS and/or DAS interrogator is positioned at a topside/onshore location, and a second DTS and/or DAS interrogator is positioned at a subsea location. The subsea interrogator receives and interrogates one or more optical signals output from the topside/onshore interrogator, while the topside/onshore interrogator receives and interrogates one or more optical signals output from the subsea interrogator.

Yet another aspect of the present disclosure relates to a system in which a subsea electrical power supply is used to power a subsea fiber optic booster and/or other control loads along the length of a subsea fiber optic cable. Using a subsea repeater and or subsea booster powered, for example, by an optical laser would increase the “optical strength” of the fiber optic system, thereby providing improved fiber optic signal quality through the subsea fiber optic system without requiring a dedicated subsea electrical circuit. Other subsea optical booster options may be considered as well, such as the use of an erbium doped optical fiber amplifier (EDFA), either powered by optical laser or other power sources.

The use of the terms “about”, “approximately”, and similar terms applies to all numeric values, whether or not explicitly indicated. These terms generally refer to a range of numbers that one of ordinary skill in the art would consider as a reasonable amount of deviation to the recited numeric values (i.e., having the equivalent function or result). For example, this term may be construed as including a deviation of ±10 percent of the given numeric value provided such a deviation does not alter the end function or result of the value. Therefore, a value of about 1% may be construed to be a range from 0.9% to 1.1%. Furthermore, a range may be construed to include the start and the end of the range. For example, a range of 10% to 20% (i.e., range of 10%-20%) includes 10% and also includes 20%, and includes percentages in between 10% and 20%, unless explicitly stated otherwise herein. Similarly, a range of between 10% and 20% (i.e., range between 10%-20%) includes 10% and also includes 20%, and includes percentages in between 10% and 20%, unless explicitly stated otherwise herein.

It is understood that when combinations, subsets, groups, etc. of elements are disclosed (e.g., combinations of components in a composition, or combinations of steps in a method), that while specific reference of each of the various individual and collective combinations and permutations of these elements may not be explicitly disclosed, each is specifically contemplated and described herein. By way of example, if an item is described herein as including a component of type A, a component of type B, a component of type C, or any combination thereof, it is understood that this phrase describes all of the various individual and collective combinations and permutations of these components. For example, in some embodiments, the item described by this phrase could include only a component of type A. In some embodiments, the item described by this phrase could include only a component of type B. In some embodiments, the item described by this phrase could include only a component of type C. In some embodiments, the item described by this phrase could include a component of type A and a component of type B. In some embodiments, the item described by this phrase could include a component of type A and a component of type C. In some embodiments, the item described by this phrase could include a component of type B and a component of type C. In some embodiments, the item described by this phrase could include a component of type A, a component of type B, and a component of type C. In some embodiments, the item described by this phrase could include two or more components of type A (e.g., A1 and A2). In some embodiments, the item described by this phrase could include two or more components of type B (e.g., B1 and B2). In some embodiments, the item described by this phrase could include two or more components of type C (e.g., C1 and C2). In some embodiments, the item described by this phrase could include two or more of a first component (e.g., two or more components of type A (A1 and A2)), optionally one or more of a second component (e.g., optionally one or more components of type B), and optionally one or more of a third component (e.g., optionally one or more components of type C). In some embodiments, the item described by this phrase could include two or more of a first component (e.g., two or more components of type B (B1 and B2)), optionally one or more of a second component (e.g., optionally one or more components of type A), and optionally one or more of a third component (e.g., optionally one or more components of type C). In some embodiments, the item described by this phrase could include two or more of a first component (e.g., two or more components of type C (C1 and C2)), optionally one or more of a second component (e.g., optionally one or more components of type A), and optionally one or more of a third component (e.g., optionally one or more components of type B).

If a component of a figure is described but not expressly shown or labeled in that figure, the label used for a corresponding component in another figure may be inferred to that component. Conversely, if a component in a figure is labeled but not described, the description for such component may be substantially the same as the description for the corresponding component in another figure. For any figure shown and described herein, one or more of the components may be omitted, added, repeated, and/or substituted. Accordingly, embodiments shown in a particular figure should not be considered limited to the specific arrangements of components shown in such figure.

Further, a statement that a particular embodiment (e.g., as shown in a figure herein) does not have a particular feature or component does not mean, unless expressly stated, that such embodiment is not capable of having such feature or component. For example, for purposes of present or future claims herein, a feature or component that is described as not being included in an example embodiment shown in one or more particular drawings is capable of being included in one or more claims that correspond to such one or more particular drawings herein.

Terms such as “first”, “second”, “primary,” “secondary,” “above”, “below”, “inner”, “outer”, “distal”, “proximal”, “end”, “top”, “bottom”, “upper”, “lower”, “side”, “left”, “right”, “front”, “rear”, and “within”, when present, are used merely to distinguish one component (or part of a component or state of a component) from another. This list of terms is not exclusive. Such terms are not meant to denote a preference or a particular orientation, and they are not meant to limit embodiments of earth penetrating tools. In the following detailed description of the example embodiments, numerous specific details are set forth in order to provide a more thorough understanding of the invention. However, it will be apparent to one of ordinary skill in the art that the invention may be practiced without these specific details. In other instances, well-known features have not been described in detail to avoid unnecessarily complicating the description.

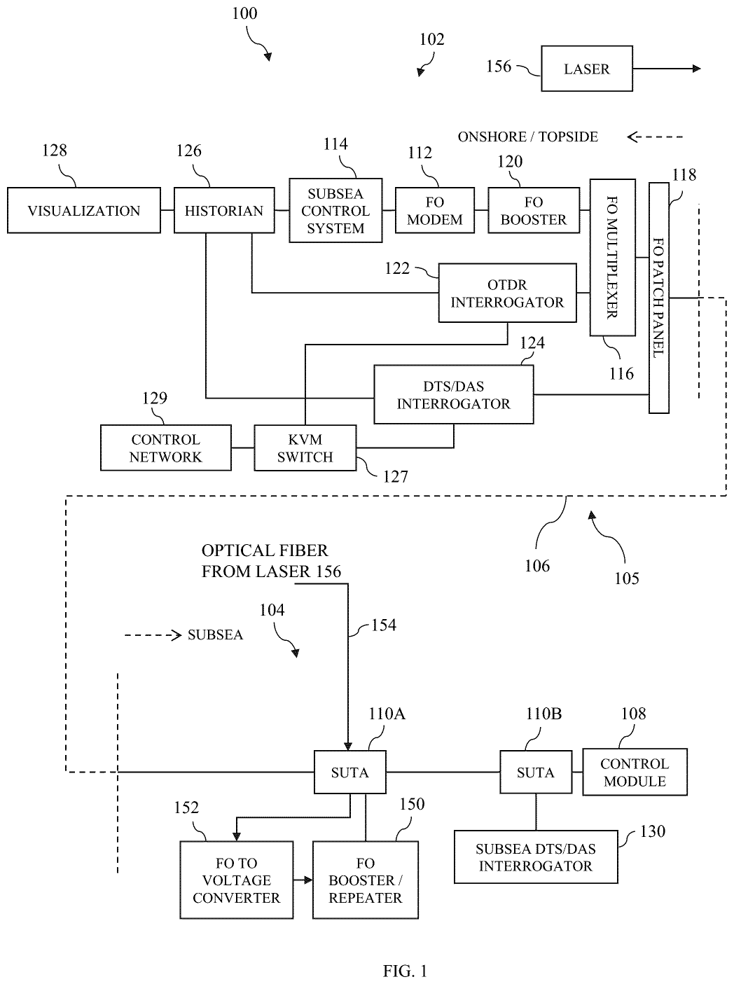

FIG. 1 is a block diagram illustrating an example fiber optic system 100 in accordance with certain embodiments of the present disclosure. The fiber optic system 100 is divided into an onshore/topside section 102 and a subsea section 104. Onshore/topside refers to a location that is not subsea (e.g., either located onshore or in a topside facility above the water's surface). The various components of the onshore/topside section 102 may be located at the same general location or may be distributed across multiple onshore/topside locations. The subsea section 104 includes components that are located at one or more subsea locations. A subsea location(s) may include a shallow water location, a deepwater location, or a combination thereof, and may be subjected to warm seawater, cold seawater, or a combination thereof.

One or more fiber optic cables 105 extend between the onshore/topside components (in section 102) and the subsea components (in section 104). Only one such fiber optic cable 105 is illustrated in FIG. 1. The one or more fiber optic cables 105 may each include at least one optical fiber 106. The one or more fiber optic cables 105 may include multiple optical fibers 106 that are packaged together into an umbilical extending from an onshore/topside location to a subsea location. Each optical fiber 106 may be used to transmit optical signals from a topside or onshore location to equipment at a subsea location. In some embodiments, the optical signals may include control signals for controlling one or more subsea equipment. In some embodiments, the optical signals may include communications or sensing signals. The equipment at the subsea location may include a subsea control module 108, as shown, or any other desired component of subsea equipment that can receive communications, control, or sensing signals from optical fiber(s) 106. The subsea control module 108 may be configured to control the operation of subsea equipment (e.g., a valve, pump, compressor, etc.). The subsea control module 108 may be integrated into or separate from/coupled to the subsea equipment being controlled.

Although not shown explicitly in FIG. 1, the system 100 may include a subsea umbilical alongside or incorporated with the fiber optic cable(s) 105. In addition, the system 100 may include one or more subsea umbilical termination assemblies (SUTA) 110 located along the length of the fiber optic cable(s) 105. For example, in FIG. 1 the system includes two SUTAs 110, one (110A) at a mid-line position along the length of the fiber optic cable(s) 105 and the other (110B) at a terminal end of the fiber optic cable(s) 105. However, other embodiments of a fiber optic system may not include these SUTAs 110A/B, or may include only one SUTA 110. Each SUTA 110 may include one or more optical connectors. There may also be one or more optical connectors at other locations, such as the interface between fiber optic cables and subsea equipment. Other components that may be part of the subsea section 104 of the fiber optic system 100 will be described in detail below.

The onshore/topside section 102 of the fiber optic system 100 includes at least a fiber optic modem 112 located topside/onshore and coupled to the one or more optical fiber(s) 106 of the system 100. The fiber optic modem 112 may be configured to transmit and receive optical signals (e.g., in the form of light signals) to the optical fiber(s) 106. The system 100 may also include a subsea control system 114 located onshore/topside for interfacing with the fiber optic modem 112. In some embodiments, a fiber optic multiplexer 116, a fiber optic patch panel 118, or both (as shown in FIG. 1) may be located between the modem 112 and the optical fiber(s) 106. To reduce decibel losses and ultimately increase the range of signals transmitted along the length of the optical fiber(s) 106, a fiber optic booster 120 may be incorporated into the onshore/topside section 102 of the system 100 as well. As shown, the fiber optic booster 120 may be located between the modem 112 and the multiplexer 116 and/or patch panel 118. However, in other embodiments the relative locations of these components may be changed. Other components that may be part of the onshore/topside section 102 of the fiber optic system 100 will be described in detail below.

The illustrated fiber optic system 100 of FIG. 1 includes multiple features that may provide continuous integrity monitoring and/or improved optical strength to the system 100. These features are described below under different headings. Each feature may be used independently of the other features described under the same or other headings. In addition, various combinations of the independent features may be used to provide advantages to the subsea fiber optic system architecture. FIG. 1 shows one such combination of the various features that allows continuous integrity monitoring of the subsea fiber optic system using fibers in service.

### Integrity Monitoring During Fiber Optic System Operations

In certain embodiments, the subsea fiber optic system 100 may enable OTDR measurements to be taken along one or more optical fibers 106 during regular operations of the fiber optic system 100 (i.e., transmitting or receiving communications, control, and/or sensing through the one or more subsea optical fibers). For example, the subsea fiber optic system 100 includes at least one optical fiber 106 for transmitting or receiving optical signals from the topside or onshore location to equipment (e.g., a control module 108) at a subsea location and the modem 112 coupled to the optical fiber 106 and configured to output optical signals to the optical fiber 106. In addition, as shown in FIG. 1, the subsea fiber optic system 100 may include an OTDR interrogator 122 located topside/onshore (in section 102) and coupled to the optical fiber 106. As illustrated, the OTDR interrogator 122 may monitor one or more of the subsea optical fibers 106 in the system through a fiber optic multiplexer 116. The OTDR interrogator 122 may be configured to provide continuous integrity monitoring of the optical fiber 106 without interrupting the optical signals being transmitted or received between the modem 112 and the optical fiber 106.

The OTDR interrogator 122 may include a light source for sending an OTDR test optical signal down the optical fiber 106 coupled to the OTDR interrogator 122 and a light detector for detecting reflected, refracted, and/or backscattered light from the optical fiber 106. The detected signals received at the OTDR interrogator 122 may be used to determine the quality of the optical fiber 106 and/or overall health of the subsea fiber optic system 100. For example, through sending and receiving optical signals via the OTDR interrogator 122, the OTDR interrogator 122 may generate a “fingerprint” for the optical fiber 106, which provides a status of the subsea fiber optic system health.

To avoid interruption of and spectral interference with communications along the one or more optical fibers 106, the OTDR interrogator 122 may output its fiber optic signal at a different wavelength or frequency than the signals transmitted or received by the fiber optic modem 112. For example, the modem 112 may output optical signals at a particular wavelength (e.g., 1550 nm), and the OTDR interrogator 122 may take measurements at a different wavelength (e.g., 1650 nm). As such, the OTDR interrogator 122 may be able to perform measurements without affecting control, communication, and sensing signals that are performed at different frequencies along the optical fiber(s) 106. The OTDR interrogator 122 may be coupled to multiple optical fibers 106 via the multiplexer 116 (e.g., shown in FIG. 1) so that the OTDR measurement can be performed on and used to measure the integrity of each subsea optical fiber system. For each optical fiber system, the OTDR interrogator 122 may operate at a different frequency than the modem frequency.

The disclosed OTDR interrogator 122 may be a separate component from the fiber optic modem 112, as shown. In certain embodiments, the OTDR interrogator 122 may be added to an existing subsea fiber optic system 100 as a retrofit option to facilitate continuous integrity monitoring of the optical fiber(s) 106 of the subsea fiber optic system 100 without requiring installation of an entirely new system.

In addition to OTDR measurements for integrity monitoring, the subsea fiber optic system 100 may also provide DAS and/or DTS measurements. DAS measurements may use one dedicated optical fiber with a maximum sensing range of approximately 75-80 km. DAS measurements may be used to: detect electrical faults in power umbilicals or submarine cables, detect dropped objects, detect fishing or shipping activities, and detect other events in the subsea environment. DTS measurements, which provide temperature sensing based on Raman, Rayleigh, and Brillouin technologies, may use two dedicated fibers looped subsea with a maximum sensing range of approximately 75-80 km. DTS measurements may be used to: detect hot spots with excessive temperatures along the length of the subsea optical fiber(s) 106, detect a fault along nearby electrical cable, or measure temperature profile at desired locations along the length of the subsea optical fiber(s) 106.

As shown in FIG. 1, the subsea fiber optic system 100 may include a DAS and/or DTS interrogator 124 located topside/onshore (in section 102) and coupled to one or more optical fibers 106 to provide acoustic, temperature, and/or vibration sensing along the optical fiber(s) 106. A DAS interrogator (124) may output light signals to an optical fiber 106, and the light signals respond to acoustic and/or vibration events along the length of the optical fiber 106. Reflections of the light signals are captured by the DAS interrogator (124) to determine acoustic and/or vibration measurements along the optical fiber 106. A DTS interrogator (124) may output light signals to an optical fiber 106, and the light signals respond to different temperatures along the length of the optical fiber 106. Backscattering of the light signals are captured by the DTS interrogator (124) to determine temperature measurements along the length of the optical fiber 106. The optical signals used to provide DTS measurements may be output in a certain frequency range necessary for the temperature sensing. If the same optical fiber 106 will be used to provide both DTS/DAS measurements and regular communications, control signals, and/or sensing signals from the fiber optic modem, the signals output from the fiber optic modem 112 may be shifted to a frequency range outside of the DTS/DAS frequency range.

The DAS and/or DTS interrogator 124 may be configured to provide integrity monitoring of an optical fiber 106 without interrupting the optical signals being output from the modem 112 to the optical fiber 106. The DAS and/or DTS interrogator 124 may be communicatively coupled to one or more of the subsea optical fibers 106 in the system. As illustrated, the DAS and/or DTS interrogator 122 may be coupled to one or more subsea optical fibers 106 via a fiber optic patch panel 118.

In certain embodiments, the DAS and/or DTS interrogator 124 may be coupled to and provide acoustic, temperature, and/or vibration sensing along the same optical fiber(s) 106 along which the OTDR measurements are provided. In other embodiments, the DAS and/or DTS interrogator 124 may be coupled to and provide acoustic, temperature, and/or vibration sensing along a different optical fiber 106 than the fiber(s) 106 along which the OTDR measurements are provided. In certain embodiments, the DAS and/or DTS interrogator 124 may be coupled to and provide acoustic, temperature, and/or vibration sensing along the same optical fiber(s) 106 along which regular controls and communications are output from the fiber optic modem 112. In other embodiments, the DAS and/or DTS interrogator 124 may be coupled to and provide acoustic, temperature, and/or vibration sensing along a different optical fiber 106 than the fiber(s) 106 along which regular controls and communications are output from the fiber optic modem 112. As one non-limiting example, the fiber optic modem 112 may be coupled to a first optical fiber, the DAS and/or DTS interrogator 124 may be coupled to a second optical fiber different from the first optical fiber, and the OTDR interrogator 122 may also be coupled to the second optical fiber. In some embodiments, the OTDR interrogator 122 may also be coupled to the first optical fiber to provide integrity monitoring on both the regular control and communication lines as well as the acoustic, temperature, and/or vibration sensing lines.

Any desired number of subsea optical fibers 106 (e.g., 1, 2, 3, 4, 5, 6, 7, 8, 9, 10, or more subsea optical fibers) may be used in the subsea fiber optic system 100 of FIG. 1. The optical fiber(s) 106 may each be dedicated to any combination of regular controls and communications from the fiber optic modem 112, OTDR measurements, and DAS and/or DTS measurements. For systems in which the same optical fiber 106 is used for multiple different purposes (e.g., communications/controls, OTDR, DAS/DTS), the optical signals output therethrough may each have different frequencies, as discussed above.

The OTDR interrogator 122 may automatically take measurements at regular intervals (e.g., every hour, every 12 hours, every 24 hours, etc.) throughout operations of the subsea fiber optic system 100. As illustrated, the subsea fiber optic system 100 may include a historian 126 communicatively coupled to the OTDR interrogator 122. The historian 126 may store the regular OTDR measurements therein and share to a post-processing dashboard package that can compare the measurements over time to identify, at an early stage, any changes in the condition of the optical fiber(s) 106 coupled to the OTDR interrogator 122. The subsea fiber optic system 100 may notify an operator (e.g., through an alert output by the integrity monitoring dashboard) when OTDR measurements deviate from baseline. For example, the system 100 may output an alert when the OTDR measurements are outside a certain range, are above or below a threshold, change over a short period, or are steadily trending in a new direction. These circumstances may indicate that the optical fiber 106 is subject to optical degradation affecting the optical fiber system performance or the optical fiber system 100 is not operating as expected. The OTDR measurements may also be analyzed to identify an approximate location along the length of the optical fiber(s) 106 where the change or issue is occurring.

The system may operate the OTDR interrogator 122 throughout subsea fiber optic operations to take measurements at regular intervals, while the system may operate the DAS and/or DTS interrogator 124 on an as needed basis. Such operation of the DAS and/or DTS interrogator 124 may be triggered by an output from the OTDR interrogator 122. That is, the OTDR interrogator 122 may determine that an issue or change has occurred along the length of the optical fiber(s) 106, and the DAS/DTS interrogator 124 may then respond by detecting acoustic, temperature, and/or vibration information that may indicate what happened along the length of the optical fiber(s) 106. For example, the DTS/DAS information may indicate whether the change is related to a dropped object, fishing or shipping activities, a fault, or excessive temperatures along the length of the optical fiber(s) 106. Upon determining the expected issue and location thereof, an ROV intervention may be required for further investigation. As illustrated, the subsea fiber optic system 100 may include a visualization component 128 (e.g., user interface) through which alerts from the integrity monitoring dashboard and details regarding the expected issue and location thereof can be displayed to a user.

As shown in FIG. 1, the DTS and/or DAS interrogator 124 may be coupled to the historian 126. In certain embodiments, the DTS and/or DAS interrogator 124 may automatically take measurements at regular intervals throughout operations of the subsea fiber optic system 100, similar to the OTDR interrogator 122. The system may also include a keyboard, video, mouse (KVM) switching device 127 and a control network 129.

### Long Range DAS/DTS Measurements

In certain embodiments, the subsea fiber optic system 100 may enable long-distance DAS and/or DTS measurements using a DAS and/or DTS interrogator 130 positioned subsea (in section 104) and another DAS and/or DTS interrogator 124 located topside/onshore (in section 102). This arrangement may enable DAS and/or DTS measurements taken along subsea optical fibers 106 extending up to 150 km, 160 km, or more. This essentially doubles the distance of existing DAS/DTS measurements on subsea fiber optic cables 105.

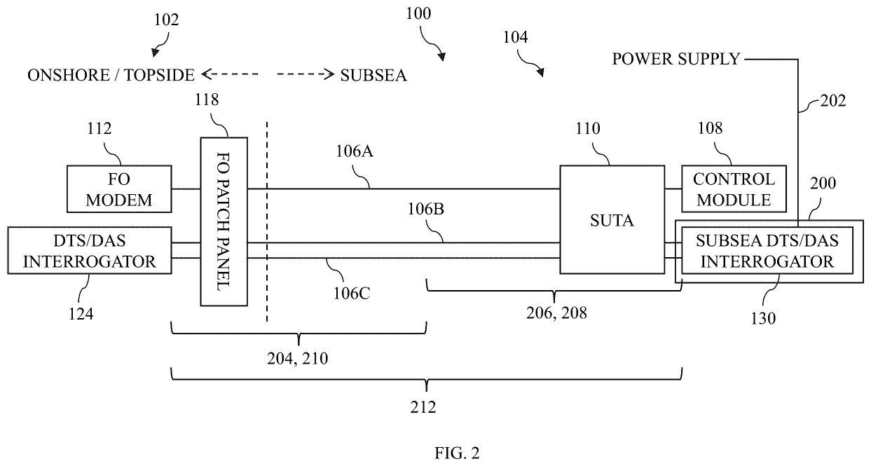

In an embodiment shown in greater detail in FIG. 2, the subsea fiber optic system 100 includes a first optical fiber 106A for transmitting optical signals from the topside or onshore location to equipment (e.g., a control module 108) at a subsea location, and the modem 112 coupled to the first optical fiber 106A and configured to output optical signals to the first optical fiber 106A. In addition, the subsea fiber optic system 100 may include a second optical fiber 106B and a third optical fiber 106C each extending between the topside or onshore location (in section 102) and the subsea location (in section 104). The first, second, and and/or third optical fibers 106 may be packaged together in a single fiber optic cable 105 and/or in a single umbilical extending between the onshore/topside location and the subsea location. In other embodiments, one or more of the optical fibers 106 may be contained in independent fiber optic cables 105.

As shown in FIG. 2, the fiber optic system 100 may include a first DAS and/or DTS interrogator 124 located topside/onshore. The first DAS and/or DTS interrogator 124 may be coupled to one end of both the second optical fiber 106B and the third optical fiber 106C. In addition, the subsea fiber optic system 100 may also include a second DAS and/or DTS interrogator 130 located subsea and coupled to the opposite end of both the second optical fiber 106B and the third optical fiber 106C. One or more additional fibers (not shown) may be communicatively coupled between the second DAS and/or DTS interrogator 130 located subsea and a surface location for communicating the sensor measurements collected by the subsea interrogator 130 to the surface for further processing. The second DAS and/or DTS interrogator 130 may be enclosed in a subsea assembly 200 suitable for a subsea environment. The second DAS and/or DTS interrogator 130 may operate using electrical power supplied to the subsea interrogator 130 from a power supply 202. Although the power supply 202 is illustrated as being separate from the optical fibers 106, in other embodiments, the optical fibers 106 may be combined into an umbilical along with an electric cable (power supply 202) used to supply electrical power to the subsea interrogator 130. The power supply 202 could be through a subsea umbilical or through other subsea power supply means such as, for example, a subsea battery, UPS, etc.

The first DAS and/or DTS interrogator 124 may be configured to output optical signals to the second optical fiber 106B and receive optical signals from the third optical fiber 106C. The second DAS and/or DTS interrogator 130 is configured to output optical signals to the third optical fiber 106C and receive optical signals from the second optical fiber 106B. As such, each interrogator 124, 130 outputs optical signals to one optical fiber 106B, 106C and receives signals from the other optical fiber 106C, 106B. The first DAS and/or DTS interrogator 124 outputs a signal to the second optical fiber 106B, and receives and analyzes the back reflected (DAS) or subsea return signal (DTS) to interpret relevant acoustic, temperature, and/or vibration data along a first portion 204 (e.g., the first 75-80 km) of the optical fiber 106B and then reflects the measurements through the remaining portion 206 of the optical fiber 106B. The reflections indicating the acoustic, temperature, and/or vibration measurements are then received at the second (subsea) DAS and/or DTS interrogator 130. As such, the second DAS and/or DTS interrogator 130 may provide acoustic, temperature, and/or vibration sensing along the first portion 204 of the second optical fiber 106B (i.e., along the 75-80 km closest to the topside/onshore end). The second (subsea) DAS and/or DTS interrogator 130 outputs a signal to the third optical fiber 106C, which measures acoustics, temperature, and/or vibrations along a first portion 208 (e.g., the first 75-80 km closest to the subsea end) of the optical fiber 106C and then reflects the measurements through the remaining portion 210 of the optical fiber 106C. The reflections indicating the acoustic temperature, and/or vibration measurements are then received at the first (topside/onshore) DAS and/or DTS interrogator 124. As such, the first DAS and/or DTS interrogator 124 may provide acoustic, temperature, and/or vibration sensing along the first portion 208 of the third optical fiber 106C (i.e., along the 75-80 km closest to the subsea end). Although in the illustrated embodiment the first portions 204, 208 of each optical fiber 106B, 106C is the same distance as the second portions 206, 210 of the optical fibers, in other embodiments the first portions 204, 208 may be longer than the second portions 206, 210. As such, a portion of the measurements taken by the different interrogators 124, 130 may overlap toward the center of the optical fibers 106.

The measurements from both DAS and/or DTS interrogators 124, 130 may be combined to provide a full measurement of the acoustics, temperature, and/or vibrations along an entire length 212 of the optical fibers 106 extending between the topside/onshore location and the subsea equipment. The DAS and/or DTS interrogators 124, 130 may be configured to provide acoustic, temperature, and/or vibration sensing across a total distance between the first interrogator and the second interrogator, the total distance being greater than 100 km, more particularly greater than 150 km, or more particularly greater than 160 km. The use of two DAS and/or DTS interrogators 124, 130 on opposite ends of the optical fibers 106 may provide up to 150 km, 160 km, or more of DAS/DTS measurements.

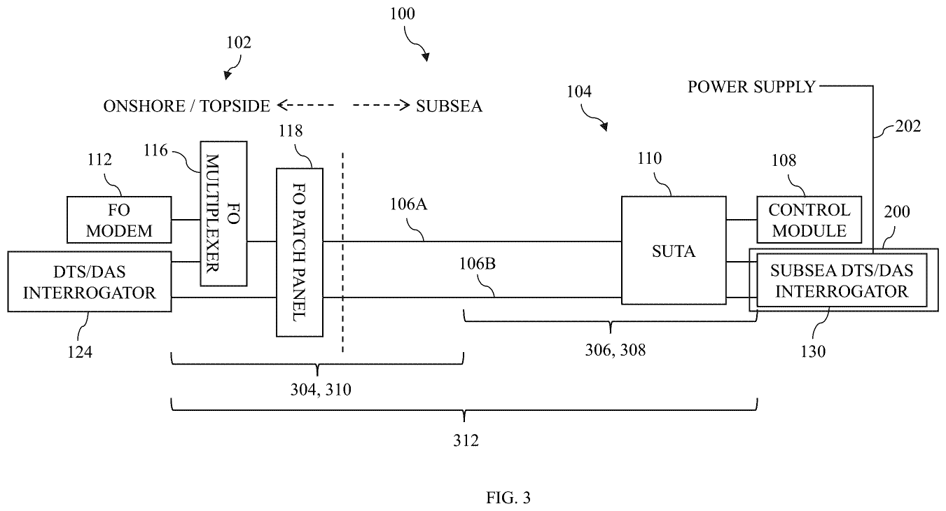

As discussed above, either of the optical fibers 106B, 106C extending between the two DAS/DTS interrogators 124, 130 may also be used to transmit or receive communications/control signals from the fiber optic modem 112 to the subsea equipment if the signal wavelengths are modified appropriately. That is, the same optical fiber 106 may serve multiple communication functions. Such an embodiment is illustrated in detail in FIG. 3.

As shown in FIG. 3, the subsea fiber optic system 100 may include a first optical fiber 106A for exchanging optical communications/control signals between a topside or onshore FO modem 112 to equipment (e.g., a control module 108) at a subsea location. In addition, the subsea fiber optic system 100 may include a second optical fiber 106B extending between the topside or onshore location (in section 102) and the subsea location (in section 104). The first and second optical fibers 106 may be packaged together in a single fiber optic cable 105 and/or in a single umbilical extending between the onshore/topside location and the subsea location.

Further, the fiber optic system 100 may include a first DAS and/or DTS interrogator 124 located topside/onshore. The first DAS and/or DTS interrogator 124 may be coupled to both the first optical fiber 106A and the second optical fiber 106B. In addition, the subsea fiber optic system 100 may include a second DAS and/or DTS interrogator 130 located subsea and coupled to both the first optical fiber 106A and the second optical fiber 106B. One or more additional fibers (not shown) may be communicatively coupled between the second DAS and/or DTS interrogator 130 located subsea and a surface location for communicating the sensor measurements collected by the subsea interrogator 130 to the surface for further processing. The second DAS and/or DTS interrogator 130 may be enclosed in a subsea assembly 200 suitable for a subsea environment. The second DAS and/or DTS interrogator 130 may operate using electrical power supplied from a power supply 202. Although the power supply 202 is illustrated as being separate from the optical fibers 106, in other embodiments, the optical fibers 106 may be combined into an umbilical along with an electric cable (power supply 202) used to supply electrical power to the subsea interrogator 130. The power supply 202 could be through a subsea umbilical or through other subsea power supply means such as, for example, a subsea battery, UPS, etc.

The first DAS and/or DTS interrogator 124 may be configured to output optical signals to the first optical fiber 106A and receive optical signals from the second optical fiber 106B. The second DAS and/or DTS interrogator 130 is configured to output optical signals to the second optical fiber 106B and receive optical signals from the first optical fiber 106A. As such, each interrogator 124, 130 outputs optical signals to one optical fiber 106A, 106B and receives signals from the other optical fiber 106B, 106A. The optical signals received from the first optical fiber 106A at the second interrogator 130 may be different from the optical signals being exchanged through the first optical fiber 106A between the topside/onshore location (e.g., modem 112) and equipment at the subsea location (e.g., control module 108). In particular, the optical signals received from the first optical fiber 106A at the second interrogator 130 may have different signal wavelengths than the optical signals being exchanged through the first optical fiber 106A between the topside/onshore location and equipment at the subsea location. The SUTA 110 or alternately an interconnecting device may include a demultiplexer to separate the different optical signals for delivery to the subsea equipment and the second DAS and/or DTS interrogator 130.

The first DAS and/or DTS interrogator 124 outputs a signal to the first optical fiber 106A, and receives and analyzes the back reflected (DAS) or subsea return signal (DTS) to interpret relevant acoustic, temperature, and/or vibration data along a first portion 304 (e.g., the first 75-80 km) of the optical fiber 106A and then reflects the measurements through the remaining portion 306 of the optical fiber 106A. The reflections indicating the acoustic, temperature, and/or vibration measurements are then received at the second (subsea) DAS and/or DTS interrogator 130. As such, the second DAS and/or DTS interrogator 130 may provide acoustic, temperature, and/or vibration sensing along the first portion 304 of the first optical fiber 106A (i.e., along the 75-80 km closest to the topside/onshore end). The second (subsea) DAS and/or DTS interrogator 130 outputs a signal to the second optical fiber 106B, which measures acoustics, temperature, and/or vibrations along a first portion 308 (e.g., the first 75-80 km closest to the subsea end) of the optical fiber 106B and then reflects the measurements through the remaining portion 310 of the optical fiber 106B. The reflections indicating the acoustic, temperature, and/or vibration measurements are then received at the first (topside/onshore) DAS and/or DTS interrogator 124. As such, the first DAS and/or DTS interrogator 124 may provide acoustic, temperature, and/or vibration sensing along the first portion 308 of the second optical fiber 106B (i.e., along the 75-80 km closest to the subsea end). Although in the illustrated embodiment the first portions 304, 308 of the optical fibers 106A, 106B are the same distance as the second portions 306, 310 of the optical fibers, in other embodiments the first portions 304, 308 may be longer than the second portions 306, 310. As such, a portion of the measurements taken by the different interrogators 124, 130 may overlap toward the center of the optical fibers 106.

The measurements from both DAS and/or DTS interrogators 124, 130 may be combined to provide a full measurement of the acoustics, temperature, and/or vibrations along an entire length 312 of the optical fibers 106 extending between the topside/onshore location and the subsea equipment. In particular, the DAS and/or DTS interrogators 124, 130 may be configured to provide acoustic, temperature, and/or vibration sensing across a total distance between the first interrogator and the second interrogator, the total distance being greater than 100 km, more particularly greater than 150 km, or more particularly greater than 160 km. Again, the use of two DAS and/or DTS interrogators 124, 130 on opposite ends of the optical fibers 106 may provide up to 150 km, 160 km, or more of DAS/DTS measurements.

Increasing Optical Strength with Subsea Booster or Subsea Repeater

When long fiber optic cables 106 are used in subsea applications, the fiber optic system can experience reduced “optical strength” as the signal loses strength along the length of the optical fiber(s) 106. For an optical signal to be picked up by subsea equipment, the signal must be above a certain decibel level so that it is not considered noise. Turning back to FIG. 1, in certain embodiments, the subsea fiber optic system 100 may boost the optical signals being communicated through the long subsea optical fiber(s) 106 to counteract undesired decibel losses and provide communications/control to subsea equipment.

In an embodiment, the subsea fiber optic system 100 includes an optical fiber 106 for transmitting optical signals from the topside or onshore location (in section 102) to equipment (e.g., a control module 108) at a subsea location (in section 104), and the modem 112 coupled to the optical fiber 106 and configured to output optical signals to the optical fiber 106. It should be noted that the “optical fiber 106” may include multiple individual fibers connected substantially end-to-end and that together are able to convey an optical signal along the length of the connected fibers. In addition, the subsea fiber optic system 100 may include a fiber optic booster/repeater 150 located subsea at an interconnection point, for example a mid-line position, along the optical fiber 106. As shown in the example embodiment of FIG. 1, the fiber optic booster/repeater 150 may be coupled to the optical fiber 106 at a subsea umbilical termination assembly (SUTA) 110A at the mid-line interconnection of the optical fiber 106. The term “booster/repeater 150” means that the element could be a subsea fiber optic booster or a subsea fiber optic repeater. A fiber optic booster (150) may be an optical amplifier configured to amplify the communications/control signals traveling through the optical fiber system 100 from the topside/onshore modem 112 to the subsea equipment. A fiber optic repeater (150) may be an optical device configured to repeat signals received by a modem and re-transmitted via an additional modem which will strengthen the communications/control signals traveling through the optical fiber system 100 from the topside/onshore modem 112 to the subsea equipment. The repeated/boosted optical signal can travel farther along the optical fiber 106 than a non-repeated/non-boosted optical signal. The fiber optic booster/repeater 150 may add another 10 dB or 20 dB to the optical signal at the mid-line interconnection of the optical fiber 106.

The subsea fiber optic booster/repeater 150 may receive power in a number of ways. In an embodiment, as shown in FIG. 1, the fiber optic booster/repeater 150 may be optically powered. For example, the fiber optic system 100 may include an opto-electric converter 152 located subsea (e.g., at the mid-line location) and electrically coupled to the fiber optic booster/repeater 150. The opto-electric converter 152 may supply electrical power to the fiber optic booster/repeater 150 for operating the fiber optic booster/repeater. An additional optical fiber 154 may extend from the topside/onshore location to the opto-electric converter 152. Although this additional optical fiber 154 is illustrated as being separate from the optical fiber(s) 106, in other embodiments, the optical fiber(s) 106 and additional optical fiber 154 may be packaged together (e.g., in the same umbilical).

The dedicated optical fiber 154 may be coupled to a high-powered laser 156 at the topside/onshore location and configured to transmit optical energy to the opto-electric converter 152. Any desired energy sources may be used to power laser amplification to the opto-electric converter 152. In some embodiments, the optical output from the laser 156 may be boosted using a topside/onshore fiber optic booster. The opto-electric converter 152 may include a subsea solar cell-type device that converts light energy to electrical energy at a certain voltage or current level. The opto-electric converter 152 and the subsea fiber optic booster/repeater 150 may be incorporated into the mid-line SUTA 110A in some embodiments. Using a dedicated optical fiber 154 to send light for powering the optical booster/repeater 150 can extend transmission of optical communications along the primary optical fiber 106 beyond its normal range, counteracting decibel losses, without requiring electrical power to be transmitted subsea.

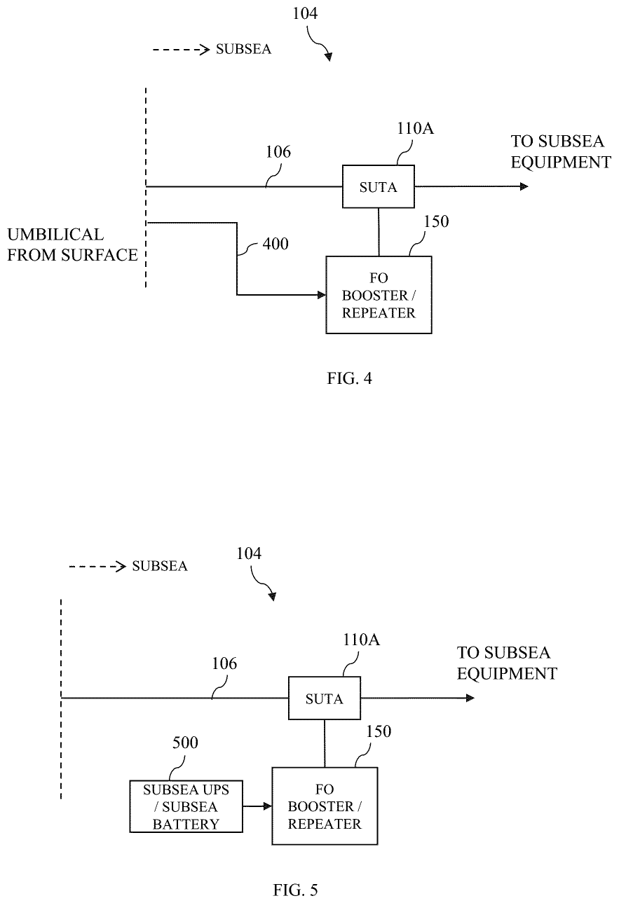

In other embodiments, the subsea fiber optic booster/repeater 150 may be powered in other ways. For example, as shown in FIG. 4, the fiber optic booster/repeater 150 may receive AC or DC electrical power from an umbilical 400 with a lead that terminates at the midline SUTA 110A. Although the umbilical 400 is illustrated as being separate from the optical fibers 106, in other embodiments, the optical fibers 106 may be combined into the umbilical 400 along with the electric cable used to supply electrical power to the fiber optic booster/repeater 150. As another example, as shown in FIG. 5, the fiber optic booster/repeater 150 may receive electric power from a subsea battery or subsea uninterrupted power supply (UPS) 500. Any other voltage source may be used to power the subsea fiber optic booster/repeater 150 in accordance with present techniques.

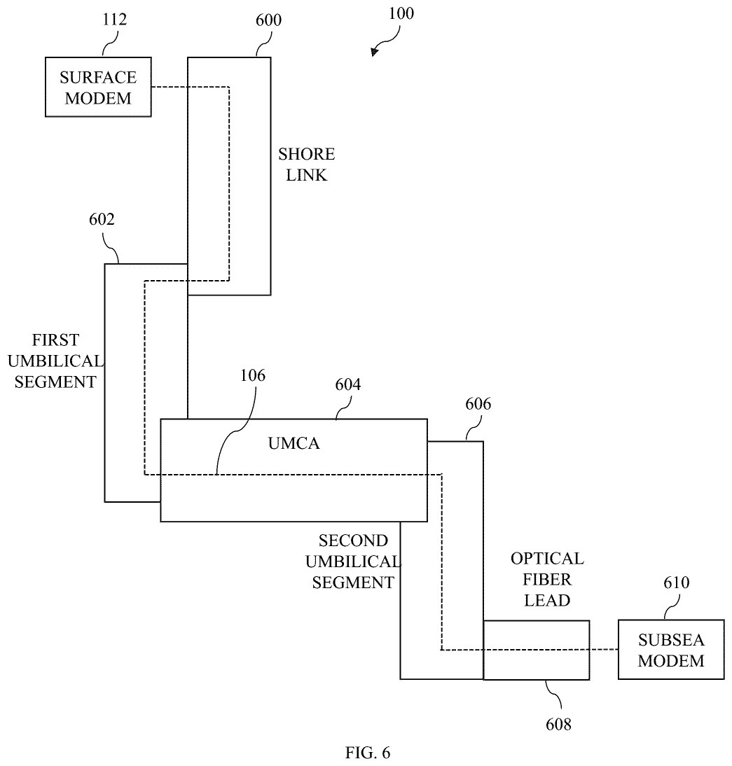

In some embodiments, the subsea fiber optic system 100 may use a subsea fiber optic booster 150 comprising an erbium doped optical fiber amplifier (EDFA). Such a fiber optic booster 150 may use any power supply coupled to the fiber optic booster 150, including those described above with reference to FIGS. 1, 4, and 5. FIG. 6 illustrates an example subsea fiber optic system 100 that may be used to transmit communications/control signals between a topside/onshore location and subsea equipment. The optical fiber 106 running from topside/onshore to the subsea equipment may include various segments along its length including, for example, a shore link 600, a first umbilical segment 602, an umbilical mid-line connection assembly (UMCA) 604, a second umbilical segment 606, and an optical fiber lead (OFL) 608 to a subsea modem 610 (e.g., modem of the subsea equipment). The fiber optic booster (e.g., 150 of FIG. 1) described above may be inserted into the UMCA segment 604. The UMCA segment 604 may include two single fiber channels, with each fiber channel operating full duplex via wavelength division multiplexing at different frequencies for the uplink and downlink lasers.

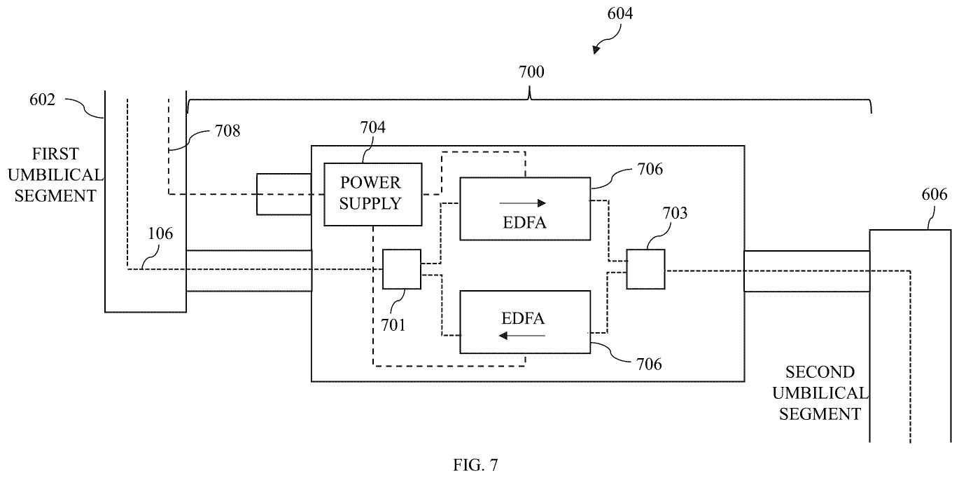

FIG. 7 illustrates an example of the UMCA 604 of FIG. 6 with an EDFA opto-electric harness 700 located therein. The EDFA opto-electric harness 700 may provide boosting of optical signals in both directions using two EDFAs 706. As shown, the EDFA opto-electric harness 700 may include wave division multiplexers (or other filters) 701 and 703 before and after the EDFAs 706 for splitting the fiber optic signals in one direction and combining the signals in the other direction. The EDFA opto-electric harness 700 may separate and boost the uplink and downlink frequencies for each fiber circuit (the diagram in FIG. 7 shows only one circuit 702). In some embodiments, the EDFA opto-electric harness 700 may include a user configurable switch to select which fibers 106 to boost. As illustrated, the EDFA opto-electric harness 700 uses an electrical power supply 704 for providing operational power to the EDFAs 706 in the harness. The electrical power supply 704 may receive electric power from a laser and fiber optic to voltage converter (as described above with reference to FIG. 1), an electrical line 708 from the umbilical (shown in FIG. 7), a subsea UPS (as described above with reference to FIG. 5), or any other electrical power supply described above.

The following illustrative embodiments are disclosed herein:

Embodiment 1: A subsea fiber optic system, including: an optical fiber for exchanging optical signals between a topside/onshore location and equipment at a subsea location; a modem located topside/onshore and coupled to the optical fiber and configured to exchange optical communications signals via the optical fiber, with another modem located subsea; an optical time domain reflectometry (OTDR) interrogator located topside/onshore, coupled to the optical fiber, and configured to provide integrity monitoring of the optical fiber without interrupting the optical communications signals being output to the optical fiber; and a multiplexer configured to allow real time switching between the optical fiber and one or more other optical fibers and thereby allow the OTDR interrogator to perform integrity monitoring for the optical fiber and the one or more other optical fibers based on the switching.

Embodiment 2: A subsea fiber optic system, including: a first optical fiber for exchanging optical signals between a topside/onshore location and equipment at a subsea location; a modem located topside/onshore and coupled to the first optical fiber and configured to exchange optical communications signals via the first optical fiber, with another modem located subsea; a second optical fiber extending from the topside/onshore location to the subsea location; a distributed acoustic sensor (DAS) and/or distributed temperature sensor (DTS) interrogator located topside/onshore and coupled to the second fiber to provide acoustic, temperature, and/or vibration sensing along the second optical fiber; an optical time domain reflectometry (OTDR) interrogator located topside/onshore, coupled to the second optical fiber, and configured to provide integrity monitoring of the second optical fiber without interrupting the acoustic, temperature, and/or vibration sensing along the second optical fiber; and a multiplexer configured to allow real time switching between the first optical fiber, the second optical fiber, and one or more other optical fibers and thereby allow the DAS, DTS, and/or OTDR interrogator to perform integrity monitoring for the first optical fiber, the second optical fiber, and the one or more other optical fibers based on the switching.

Embodiment 3: A subsea fiber optic system, including: a first optical fiber for exchanging optical signals between a topside/onshore location and equipment at a subsea location; a modem located topside/onshore and coupled to the first optical fiber and configured to exchange optical communications signals via the first optical fiber, with another modem located subsea; a second optical fiber and a third optical fiber each extending between the topside/onshore location and the subsea location; a first distributed acoustic sensor (DAS) and/or distributed temperature sensor (DTS) interrogator located topside/onshore and coupled to both the second optical fiber and the third optical fiber, wherein the first DAS and/or DTS interrogator is configured to output optical signals to the second optical fiber and receive optical signals from the third optical fiber to provide acoustic, temperature, and/or vibration sensing along a portion of the third optical fiber; and a second DAS and/or DTS interrogator located subsea and coupled to both the second optical fiber and the third optical fiber, wherein the second DAS and/or DTS interrogator is configured to output optical signals to the third optical fiber and receive optical signals from the second optical fiber to provide acoustic, temperature, and/or vibration sensing along a portion of the second optical fiber.

Embodiment 4: A subsea fiber optic system, including: a first optical fiber for exchanging optical signals between a topside/onshore location and equipment at a subsea location; a modem located topside/onshore and coupled to the first optical fiber and configured to exchange optical communications signals via the first optical fiber, with another modem located subsea; a second optical fiber extending between the topside/onshore location and the subsea location; a first distributed acoustic sensor (DAS) and/or distributed temperature sensor (DTS) interrogator located topside/onshore and coupled to both the first optical fiber and the second optical fiber, wherein the first DAS and/or DTS interrogator is configured to output optical signals to the first optical fiber and receive optical signals from the second optical fiber to provide acoustic, temperature, and/or vibration sensing along a portion of the second optical fiber; and a second DAS and/or DTS interrogator located subsea and coupled to both the first optical fiber and the second optical fiber, wherein the second DAS and/or DTS interrogator is configured to output optical signals to the second optical fiber and receive optical signals from the first optical fiber to provide acoustic, temperature, and/or vibration sensing along a portion of the first optical fiber.

Embodiment 5: A subsea fiber optic system, including: a first optical fiber for exchanging optical signals between a topside/onshore location and equipment at a subsea location; a modem located topside/onshore and coupled to the first optical fiber and configured to exchange optical communications signals via the first optical fiber, with another modem located subsea; a fiber optic booster located subsea at an interconnection point along the first optical fiber; an opto-electric converter located subsea, electrically coupled to the fiber optic booster, and configured to supply electrical power to the fiber optic booster; and a second optical fiber extending between the topside/onshore location to the opto-electric converter and configured to transmit optical energy to the opto-electric converter.

Embodiment 6: A subsea fiber optic system, including: an optical fiber for exchanging optical signals between a topside/onshore location and equipment at a subsea location; a modem located topside/onshore and coupled to the optical fiber and configured to exchange optical communications signals via the optical fiber, with another modem located subsea; a fiber optic booster located subsea at an interconnection point along the optical fiber, the fiber optic booster; and a power supply coupled to the fiber optic booster.

Embodiment 7: The system of Embodiment 6, wherein the fiber optic booster includes an erbium-doped optical fiber amplifier (EDFA).

Although embodiments described herein are made with reference to example embodiments, it should be appreciated by those skilled in the art that various modifications are well within the scope and spirit of this disclosure. Those skilled in the art will appreciate that the example embodiments described herein are not limited to any specifically discussed application and that the embodiments described herein are illustrative and not restrictive. From the description of the example embodiments, equivalents of the elements shown therein will suggest themselves to those skilled in the art, and ways of constructing other embodiments using the present disclosure will suggest themselves to practitioners of the art. Therefore, the scope of the example embodiments is not limited herein.

What is claimed is:

1. A subsea fiber optic system, comprising:
a first optical fiber for exchanging optical signals between a topside/onshore location and equipment at a subsea location;
a modem located topside/onshore and coupled to the first optical fiber and configured to exchange optical communications signals via the first optical fiber, with another modem located subsea;
a second optical fiber and a third optical fiber each extending between the topside/onshore location and the subsea location;
a first interrogator configured to collect distributed acoustic sensor (DAS) and/or distributed temperature sensor (DTS) measurements, wherein the first interrogator is located topside/onshore and coupled to both the second optical fiber and the third optical fiber, wherein the first interrogator is configured to output optical signals to the second optical fiber and receive optical signals from the third optical fiber to provide acoustic, temperature, and/or vibration sensing along a portion of the third optical fiber; and
a second interrogator configured to collect DAS and/or DTS measurements, wherein the second interrogator is located subsea and coupled to both the second optical fiber and the third optical fiber, wherein the second interrogator is configured to output optical signals to the third optical fiber and receive optical signals from the second optical fiber to provide acoustic, temperature, and/or vibration sensing along a portion of the second optical fiber.

2. The subsea fiber optic system of claim 1, wherein the first and second interrogators are configured to provide acoustic, temperature, and/or vibration sensing across a total distance between the first interrogator and the second interrogator, the total distance being greater than 100 km.

3. The subsea fiber optic system of claim 2, wherein the first and second interrogators are configured to provide acoustic, temperature, and/or vibration sensing across a total distance between the first interrogator and the second interrogator, the total distance being greater than 150 km.

4. The subsea fiber optic system of claim 1, wherein:
the first interrogator is configured to provide acoustic, temperature, and/or vibration sensing along a portion of the third optical fiber located closest to the second interrogator, based on the optical signals received from the third optical fiber; and
the second interrogator is configured to provide acoustic, temperature, and/or vibration sensing along a portion of the second optical fiber located closest to the first interrogator, based on the optical signals received from the second optical fiber.

5. The subsea fiber optic system of claim 1, further comprising a power supply to the second interrogator.

6. The subsea fiber optic system of claim 1, wherein the second interrogator is enclosed in a subsea assembly configured for use in a subsea environment.

7. A subsea fiber optic system, comprising:
a first optical fiber for exchanging optical signals between a topside/onshore location and equipment at a subsea location;
a modem located topside/onshore and coupled to the first optical fiber and configured to exchange optical communications signals via the first optical fiber, with another modem located subsea;
a second optical fiber extending between the topside/onshore location and the subsea location;
a first interrogator configured to collect distributed acoustic sensor (DAS) and/or distributed temperature sensor (DTS) measurements, wherein the first interrogator is located topside/onshore and coupled to both the first optical fiber and the second optical fiber, wherein the first interrogator is configured to output optical signals to the first optical fiber and receive optical signals from the second optical fiber to provide acoustic, temperature, and/or vibration sensing along a portion of the second optical fiber; and
a second interrogator configured to collect DAS and/or DTS measurements, wherein the second interrogator is located subsea and coupled to both the first optical fiber and the second optical fiber, wherein the second interrogator is configured to output optical signals to the second optical fiber and receive optical signals from the first optical fiber to provide acoustic, temperature, and/or vibration sensing along a portion of the first optical fiber.

8. The subsea fiber optic system of claim 7, wherein the first and second interrogators are configured to provide acoustic, temperature, and/or vibration sensing across a total distance between the first interrogator and the second interrogator, the total distance being greater than 100 km.

9. The subsea fiber optic system of claim 8, wherein the first and second interrogators are configured to provide acoustic, temperature, and/or vibration sensing across a total distance between the first interrogator and the second interrogator, the total distance being greater than 150 km.

10. The subsea fiber optic system of claim 7, wherein:
the first interrogator is configured to provide acoustic, temperature, and/or vibration sensing along a portion of the second optical fiber located closest to the second interrogator, based on the optical signals received from the second optical fiber; and
the second interrogator is configured to provide acoustic, temperature, and/or vibration sensing along a portion of the first optical fiber located closest to the first interrogator, based on the optical signals received from the first optical fiber

11. The subsea fiber optic system of claim 7, wherein the optical signals received from the first optical fiber at the second interrogator are different from the optical signals being exchanged through the first optical fiber between the topside/onshore location and equipment at the subsea location.

12. The subsea fiber optic system of claim 11, wherein the optical signals received from the first optical fiber at the second interrogator have different signal wavelengths than the optical signals being exchanged through the first optical fiber between the topside/onshore location and equipment at the subsea location.

13. A method, comprising:
outputting optical signals to a first optical fiber via a first interrogator, the first interrogator being located at a topside/onshore location, wherein the first interrogator is configured to collect distributed acoustic sensor (DAS) and/or distributed temperature sensor (DTS) measurements;
outputting optical signals to a second optical fiber via a second interrogator, the second interrogator being located subsea, wherein the second interrogator is configured to collect DAS and/or DTS measurements;
receiving optical signals from the second optical fiber via the first interrogator;
receiving optical signals from the first optical fiber via the second interrogator;
providing acoustic, temperature, and/or vibration sensing along a portion of the second optical fiber via the first interrogator based on the optical signals received from the second optical fiber; and
providing acoustic, temperature, and/or vibration sensing along a portion of the first optical fiber via the second interrogator based on the optical signals received from the first optical fiber.

14. The method of claim 13, further comprising:
measuring acoustics, temperature, and/or vibrations along the portion of the first optical fiber via the optical signals output from the first interrogator traveling through the portion of the first optical fiber;
reflecting optical signals indicative of the measured acoustics, temperature, and/or vibrations through a remaining portion of the first optical fiber to the second interrogator;
measuring acoustics, temperature, and/or vibrations along the portion of the second optical fiber via the optical signals output from the second interrogator traveling through the portion of the second optical fiber; and
reflecting optical signals indicative of the measured acoustics, temperature, and/or vibrations through a remaining portion of the second optical fiber to the first interrogator.

15. The method of claim 13, further comprising combining measurements taken from both the first and second interrogators to provide a measurement of the acoustics, temperature, and/or vibrations along an entire length of optical fibers extending between the first interrogator and the second interrogator.

16. The method of claim 15, wherein the entire length is greater than 100 km.

17. The method of claim 15, wherein the entire length is greater than 150 km.

18. The method of claim 13, further comprising communicating optical signals between a modem located at the topside/onshore location and equipment at the subsea location via a third optical fiber.

19. The method of claim 13, further comprising communicating optical signals between a modem located at the topside/onshore location and equipment at the subsea location via the first optical fiber.

20. The method of claim 19, further comprising communicating the optical signals between the modem at the topside/onshore location and the equipment at the subsea location at different signals wavelengths than the optical signals output via the first interrogator.
